(19) United States
(12) Patent Application Publication
(10) Pub. No.: US 2026/0202513 A1
(43) Pub. Date: Jul. 16, 2026

(54) Method and Control Device for Operating a Heating Device and Correspondingly Configured Motor Vehicle

(71) Applicant: Bayerische Motoren Werke Aktiengesellschaft, Muenchen (DE)

(72) Inventors: Lukas NIEDERSTEIN, Bornheim (DE); Jonathan ROTH, Muenchen (DE)

(21) Appl. No.: 19/145,009

(22) PCT Filed: Dec. 12, 2023
(86) PCT No.: PCT/EP2023/085236

§ 371 Date: Jul. 1, 2025

(30) Foreign Application Priority Data
Jan. 10, 2023 (DE) 10 2023 100 356.9

(51) Int. Cl. G01S 7/40

(52) U.S. Cl. CPC G01S 7/4047

(57) ABSTRACT

A method and a control device are disclosed for operating a heating device for heating a component exposed to an external environment in the intended installation position. In the method, if a heating requirement for the component is detected, the heating device is operated in a standard operating mode designed for dry ambient conditions. If an additional external cooling effect is detected, the system then automatically switches to a heavy-duty operating mode designed for wet ambient conditions, in which the heating device is operated at a higher power compared to the standard operating mode.

### BACKGROUND AND SUMMARY

The present invention relates to a method for operating a component heater and a control device for controlling a corresponding heating device. The invention furthermore relates to a correspondingly configured motor vehicle.

Devices are presently used in many areas and applications, the effective operation of which can be impaired by different environmental conditions or environmental influences. Of course, however, continuously robust, reliable, and effective operation is desired. Previous measures, such as cleaning or heating mechanisms, can conditionally ensure improvements, but up to this point have not solved all problems and challenges optimally in all situations.

As an example, EP 10 157 442 B1 describes a motor vehicle radar system having a body transmissive to sensor radiation or a radome, in the area of which an arrangement made of electrical conductor tracks, which is suitable for heating, is arranged. Power supplied to this arrangement is controlled here in that a voltage which falls at the conductor tracks is not constant over time. The power control is performed there depending on operating states and environmental conditions, which comprise an operating voltage, the ambient temperature, the speed of the vehicle, and the surface temperature of the body transmissive to sensor radiation or radome. A motor vehicle radar system is therefore to be specified which is better adapted to the operating states and environmental conditions.

The object of the present invention is to enable particularly reliable use of a heatable component.

This object is achieved by the subject of the independent claims. Further possible designs of the invention are disclosed in the dependent claims, the description, and the figures. Features, advantages, and possible designs which are described in the scope of the description for one of the subjects of the independent claims are to be viewed at least analogously as features, advantages, and possible designs of the respective subject matter of the other independent claims and any possible combination of the subjects of the independent claims, possibly in conjunction with one or more of the dependent claims.

The method according to the invention can be used for operating a heating device for heating a component which is exposed to an external environment in the intended installation position. This component or the heating device can be intended in particular for a motor vehicle or can be part of a motor vehicle here. In the method according to the invention, it is automatically monitored, thus, for example, measured or checked continuously or quasi-continuously or regularly, whether there is a fundamental heating need for the component. This can be determined, for example, on the basis of a temperature measurement by means of a corresponding temperature sensor, which can be arranged, for example, on the component or in the area of the component, and/or on the basis of a behavior or a characteristic of the heatable component or a device related thereto and/or on the basis of local weather or environmental conditions and/or the like. For this purpose, for example, a corresponding criterion and/or a corresponding threshold value and/or the like can be predetermined, which, if it is fulfilled or exceeded, can cause a heating need for the component to be recognized.

If such a heating need for the component is recognized, the heating device is operated in a predetermined standard operating mode, which is intended or designed for dry weather or environmental conditions. This standard operating mode can thus be designed, for example, so that therefore overheating of the component does not occur in dry environmental conditions. The standard operating mode can thus be designed, for example, primarily to ensure the component safety under all permissible usage conditions or to prioritize this component safety. The invention is based on the finding here that different weather or environmental conditions have or are accompanied by different cooling powers or cooling effects with respect to the component and dryness or wetness forms an extremely essential distinguishing and influencing factor here. Moreover, in most regions of the earth it can be excessively dry most of the time, so that at least an initial use or setting of the standard operating mode and its design for dry weather or environmental conditions can represent a particularly reasonable and useful selection. Moreover, a particularly low external cooling power or cooling effect can be provided in dry weather or environmental conditions and therefore the highest risk can be for overheating of the component with excessively high heating power of the heating device. This can be taken into consideration by its standard operating mode or its initial use or setting and the power of the heating device correspondingly limited thereby.

Furthermore, it is monitored in the method according to the invention whether there is an additional external cooling effect, which currently cools the component in each case and does not occur in dry weather or environmental conditions. Such an additional external cooling effect is thus not always present and can therefore be provided, for example, in addition to an unavoidable thermal radiation or heat dissipation from the component, which is always provided. A cooling effect which cannot be derived or recognized solely from operating parameters of the motor vehicle, such as its engine or drive power, heat production, and/or speed, can also be considered an additional external cooling effect in the present meaning. For example, an expected cooling effect due to an incident airflow can be determined from the speed or engine or drive power of the motor vehicle and therefore possibly does not represent an additional cooling effect in the meaning of the present invention, in particular if dry environmental conditions, thus also a dry state of the heatable component, are assumed or used as the basis for the determination of the cooling effect due to the incident airflow. Likewise, for example, an expected cooling effect due to a cooling device of the motor vehicle and/or due to a heat dissipation from the heating device and/or the heatable component in the intended installation position, for example, via fastening points or the like, can be known per se and therefore may not be considered an additional external cooling effect in the meaning of the present invention. Likewise, for example, a reduction of a power of the heating device and/or a change of an operating state of the heatable component or a device related thereto can result in or contribute to a cooling of the heatable component, but can be controlled or known and therefore may also not represent an additional external cooling effect in the meaning of the present invention.

Instead, an additional external cooling effect in the present sense can be generated, for example, by water, thus moisture or humidity, striking or reaching the component from the respective environment. The component can be cooled more strongly under otherwise identical conditions or operating states due to such moisture than in dry environmental conditions, for example, due to heat dissipation, dripping off or running off of heated water, evaporation, and/or the like. An occurrence of such moisture typically cannot be influenced or prevented by control measures of the component or the device related thereto or the motor vehicle and therefore represents an additional external effect in the meaning of the present invention.

If no such additional external cooling effect is recognized, the heating device at least as long as the recognized heating need is still provided-is still operated in the standard operating mode.

In contrast, if such an additional external cooling effect is recognized, a change is made automatically from the standard operating mode to a strong operating mode of the heating device, which is designed for wet weather or environmental conditions. In this strong operating mode, the heating device-for example, with otherwise equal values of considered parameters, thus, for example, the ambient temperature and/or the speed of the motor vehicle and/or the like-is operated here with greater power in comparison to the standard operating mode. Due to this increased power, the strong operating mode can also be referred to as a boost operation or boost mode. The additional external cooling effect can be entirely or partially compensated for by the strong operating mode or the correspondingly increased power of the heating device. In the strong operating mode, for example, the effectiveness of the heatable component or the device related thereto and therefore also a corresponding user utility or user comfort can thus be prioritized. The operating safety or component safety may possibly no longer be provided or maintained solely intrinsically here, but rather by or with use of the additional external cooling effect.

Due to the risk of icing of the component and a functional restriction accompanying this, there can be a fundamental need for the heating device. However, the finding has resulted in this case that the component is cooled significantly more strongly in the case of rain than in the case of sunny dry weather, for example. The present invention can take this into consideration and offer or enable a control which also incorporates the current weather, thus the current weather or environmental conditions. A functional or performance potential of the respective component or the device related thereto can therefore always be optimally utilized even in different environmental conditions. For example, the component can be a radome, wherein the device related thereto can then comprise, for example, a radar emitter and radar receiver.

In known solutions, there is typically no differentiation with respect to wet and dry weather or wet and dry environmental conditions for the control of the heating device. Rather, the control or a corresponding temperature modeling or the like is typically only designed for the dry case. Due to the introduction provided according to the invention of two different heating operating modes-in addition to a switched-off state-for the heating device or its control, it can dynamically adapt the current heating power and therefore align itself according to the respective current circumstances or conditions. The different operating modes can thus ensure, in other words, a corresponding change in the power emission of the heating device in different weather or environmental conditions. Therefore, in correspondingly different situations, the component safety can always be ensured by avoiding overheating of the component and also a particularly high level of user utility can always be ensured by heating power which is adapted or meets the need.

In a further possible design of the present invention, to recognize an additional external cooling effect-and therefore also accordingly an additional heating need or need for the strong operating mode-it is monitored whether a temperature and/or temperature change achieved by the operation of the heating device is consistent with a predetermined expected value. In this case, for example, the temperature and/or temperature change of the respective component can be observed. This can be measured, for example, by means of a temperature sensor arranged on the component or in its environment. A temperature range or a curve or a characteristic map or the like can be predetermined as the expected value, for example, depending on the heating power of the heating device and/or the ambient temperature and/or the starting temperature of the component and/or the speed of the motor vehicle and/or the like, for example. In particular, the expected value can be intended for dry weather or environmental conditions, so that deviations from the expected value in wet weather or environmental conditions can be recognized particularly reliably and robustly. The predetermined expected value can be determined or have been determined, for example, experimentally or from experiential values or by means of a corresponding predetermined temperature model and/or the like. An additional external cooling effect can be recognized here, for example, if the temperature and/or temperature change achieved is less than the predetermined expected value. Overall, the existence or presence of the or an additional external cooling effect can therefore be recognized particularly easily and effectively.

In a further possible design of the present invention, to recognize the additional external cooling effect-and therefore also accordingly an additional heating need or need for the strong operating mode-it is determined whether a rain sensor and/or an evaluation of camera images or camera image data carried out, in particular automatically, to recognize the respective current local weather conditions, indicates wet weather or environmental conditions. The rain sensor can in particular be part of the motor vehicle equipped with the component and the heating device here. The camera image data can also originate from a camera, which is directed into the respective environment, of the motor vehicle equipped with the component and the heating device. The recognition or confirmation or plausibility check of the additional external cooling effect by means of the rain sensor and/or the camera image data which is proposed here can enable a particularly reliable recognition or confirmation or plausibility check. In particular, corresponding data can already be present or available in any case, so that, for example, a correspondingly complex temperature model for the respective component and the heating device or the like can be saved.

In a further possible embodiment of the present invention, two different characteristic curves for the heating device are predetermined for the standard operating mode and the strong operating mode. The characteristic curve to be used in the strong operating mode provides a greater power at each point here than the characteristic curve to be used at the same point in the standard operating mode. In other words, the characteristic curve for the strong operating mode can thus be greater at each point than the characteristic curve for the standard operating mode or can lie above it. The power of the heating device to be used in each case can be determined particularly easily by such characteristic curves. Moreover, particularly effective heating of the respective component can be enabled by the greater power at each point according to the characteristic curve for the strong operating mode in the case of moisture in all situations or directly from the recognition of the additional external cooling effect. The heating power then does not have to be, for example, initially ramped up along the characteristic curve for the standard operating mode in order to only then be additionally increased above this. Particularly rapid and reliable usability of the respective component or the device related thereto can therefore be enabled.

In principle, at least the characteristic curve for the strong operating mode can be adapted variably or dynamically, in particular automatically, to the level or dimension of the additional external cooling effect. The level or dimension or strength of the additional external cooling effect can thus also be determined or estimated in each case. For example, in the event of a higher or greater or stronger additional external cooling effect, the characteristic curve for the strong operating mode can be elevated, thus shifted upward, i.e. in the direction of higher power. Multiple characteristic curves, thus a characteristic curve family can also be predetermined for different levels or dimensions or strengths of the additional external cooling effect for the strong operating mode. The assigned or corresponding characteristic curve can then be selected depending on the respective determined or estimated level or dimension or strength of the additional external cooling effect.

In one possible refinement of the present invention, the characteristic curves specify the power to be applied for the heating device depending on the speed of the motor vehicle equipped with the component and the heating device, can thus accordingly predetermine or define this power. In a graphic representation of the characteristic curves, for example, the speed of the motor vehicle or the speed at which ambient air flows against the motor vehicle can thus be plotted on the abscissa access and the power at which the heating device is to be operated or the component is to be heated can be or become plotted on the ordinate axis. It can be taken into consideration particularly easily by characteristic curves specified or predetermined or defined in this way that a higher cooling power or a stronger cooling of the component typically accompanies a higher speed. A respective suitable power for the heating device or for heating the respective component can therefore be determined particularly easily and adapted to the situation.

In a further possible design of the present invention, the heating device is operated in the strong operating mode using a power which can result in overheating of the component without the additional external cooling effect, thus in particular in dry weather or environmental conditions. The additional external cooling effect can thus be compensated for particularly quickly or particularly effectively, in order to enable or achieve a correspondingly rapid and reliable usability of the component or the device related thereto.

In a further possible design of the present invention, a change is made from the strong operating mode back into the standard operating mode automatically if monitoring carried out in the strong operating mode, in particular continuously or quasi-continuously, shows that the additional external cooling effect no longer exists, thus is no longer provided or is no longer active, and/or that a predetermined goal after a predetermined time span from the respective beginning of the strong operating mode has not been achieved. Such a predetermined goal can be or mean, for example, a predefined success of the operation of the heating device or reaching or meeting a predefined target criterion or success criterion. For example, reaching a specific temperature and/or temperature change and/or temperature change speed of the respective component can be predetermined as a goal. Likewise, for example, a specific improvement of a functionality or effectivity of the component or the device related thereto can be predetermined as a goal. Such an improvement can comprise or mean, for example, a specific reduction of a signal reflection, in particular interior signal reflection, on the component and/or a signal damping and/or a strength or intensity of a signal received by the component and/or the like. Additional energy or power applied for the strong operating mode can be minimized or saved by the design proposed here of the method according to the invention if it is not required or is not effective or expedient. Moreover, overheating of the component can be avoided particularly reliably thereby.

The present invention also relates to a control device which is configured for actuating, in particular automatically, a heating device for heating a component according to the method according to the invention. For this purpose, the control device can comprise a data processing device, thus, for example, a circuit and/or a processing device, thus, for example, a microchip, microprocessor, or microcontroller or the like, and a computer-readable data memory coupled thereto. A corresponding operating or computer program can be coded or stored therein, for example, which codes or implements the method steps, measures, or sequences mentioned in conjunction with the method according to the invention or corresponding control instructions. Therefore, the corresponding method can be carried out or the performance of the method can be caused, in particular automatically, for example, by activating the corresponding circuit and/or by executing the corresponding operating or computer program, which is stored in the data memory, for example, by means of the processing device.

The present invention also relates to a motor vehicle which comprises a heatable component and a heating system for heating the component, wherein the heating system comprises a heating device and the control device according to the invention. The motor vehicle according to the invention can thus likewise be configured for carrying out or applying, in particular automatically, the method according to the invention. In particular, the motor vehicle according to the invention can be the motor vehicle mentioned in conjunction with the method according to the invention or can correspond thereto. Accordingly, the motor vehicle according to the invention can comprise some or all of the properties and/or features mentioned in this context, for example, a device for determining or recognizing the respective current weather or environmental conditions, for example, the temperature sensor and/or the rain sensor and/or the camera and/or the like.

In one possible refinement of the present invention, the component heatable by means of the heating system is or comprises a radome of a radar device of the motor vehicle and/or a window of the motor vehicle, thus, for example, a windshield and/or a rear window and/or a side window and/or a windowpane and/or the like. These can be particularly useful applications of the present invention, since a corresponding heating of the radome and/or the window can enable improved environmental detection-whether by the radar device or a camera looking through the window into the respective surroundings or a driver of the motor vehicle looking through the window into the respective surroundings or the like-and can therefore contribute to improved safety in operation of the motor vehicle or in corresponding traffic events.

Further features of the invention can result from the claims, the figures, and the description of the figures. The features and combinations of features mentioned above in the description and the features and combinations of features hereinafter in the description of the figures and/or solely shown in the figures are usable not only in the respective specified combination, but also in other combinations or alone, without departing from the scope of the invention.

### BRIEF DESCRIPTION OF DRAWINGS

FIG. 1 is a schematic representation of a motor vehicle having a component which is heatable depending on the situation by means of a heating device;

FIG. 2 is a schematic representation to illustrate a method for controlling the heating device; and

FIG. 3 is a schematic diagram representation for further illustration of the control of the heating device.

### DETAILED DESCRIPTION OF DRAWINGS

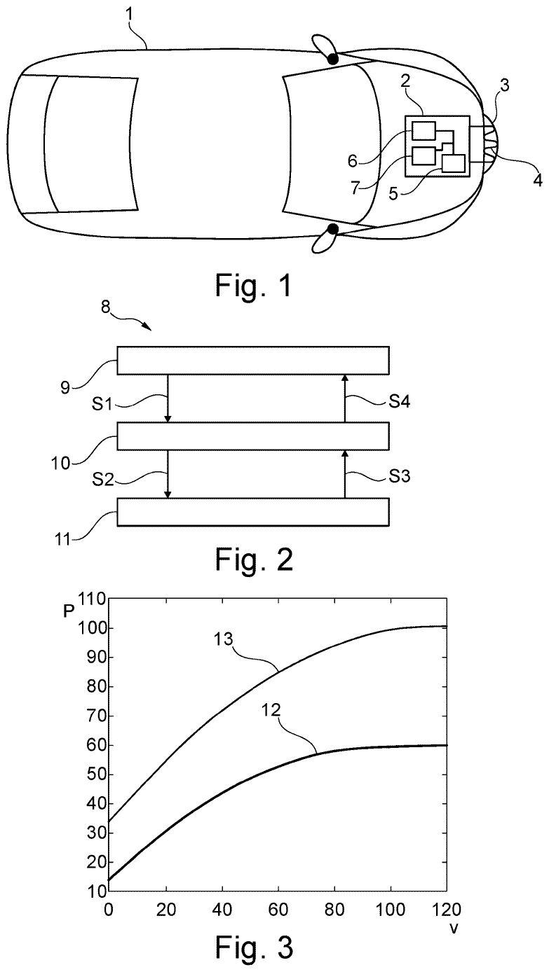

FIG. 1 shows a schematic representation of a motor vehicle 1 having a radar system 2. The radar system 2 comprises a radome 3 here, which is exposed to an external environment of the motor vehicle 1. The radome 3 is therefore susceptible, for example, to being covered by ice or snow or moisture, thus, for example, drops of rain or mist or condensing moisture or the like. To counteract corresponding impairments of the radar system 2, the radome 3 is heatable by means of a heating device. This can comprise here, for example, a heating element 4 arranged on the radome 3 or also an energy supply 5.

To enable a heating requirement, thus a requirement for an operation of the heating device, and to control the heating device or its power, the heating device or the radar system 2 comprises here, for example, a processor 6 and a data memory 7, by which, for example, a corresponding predetermined operating or computer program can be executed.

FIG. 2 shows an exemplary method scheme 8 to illustrate the operation of the heating device. A starting state 9 is initially provided therein at the beginning, thus, for example, upon startup of the motor vehicle 1 or the radar system 2. The radar system 2 can be operated therein, for example, using the designed heating device. Preceding therefrom, it can be determined in a method step S1 whether there is a heating requirement for the radome 3. If this is the case, the heating device can then be activated or operated in a predetermined or predefined standard operating mode 10, which is designed for dry environmental conditions. Furthermore, it can then be determined or checked in a method step S2 whether an additional external cooling effect is present. Such an additional external cooling effect can appear, for example, in that in the standard operating mode 10, an expected value or an expected effect of the operation of the heating device is not achieved.

If such an additional external cooling effect is recognized, it is then accordingly possible to change to a strong operating mode 11, in which the heating device is operated with power increased in relation to the standard operating mode 10. In other words, the heating device can then be operated here using a boost application.

With the strong operating mode 11 activated, it can be monitored whether the additional external cooling effect still exists and/or a predetermined goal or a predetermined expected value is achieved by the strong operating mode 11. If this is not the case, thus the additional external cooling effect disappears and/or an expected heating success does not appear within a predetermined time span, it is possible to change automatically from the strong operating mode 11 back into the standard operating mode 10 in a method step S3. An unnecessary energy consumption for the strong operating mode 11 or a correspondingly high load of the heating device and/or the radome 3 by the strong operating mode 11 can thus be avoided or limited.

It can then be monitored or checked whether a heating requirement for the radome 3 still fundamentally exists or whether a desired effect results at all due to the operation of the heating device, for example, after a predetermined longer second time span. If a heating requirement no longer exists, for example, due to a corresponding change of the environmental conditions, and/or no success results due to the operation of the heating device, it is possible to change from the standard operating mode 10 back into the starting state 9 in a method step S4, thus the heating device is switched off.

For further illustration, FIG. 3 shows an exemplary diagram representation in which the speed v of the motor vehicle 1 is plotted on the abscissa axis, for example, in km/h, and the power P of the heating device is plotted on the ordinate axis, for example, in watts. A standard characteristic curve 12 and a boost characteristic curve 13 are entered here. The standard characteristic curve 12 can be used in the standard operating mode 10, while the boost characteristic curve 13 can be used in the strong operating mode 11. The two characteristic curves 12, 13 are predetermined here such that at each point the boost characteristic curve 13 lies above the standard characteristic curve 12, thus provides a greater heating power of the heating device or the heating element 4.

Overall, the described examples show how an efficiency-optimized method for operating a window or radome heater for situation-related heating can be implemented and applied.

### LIST OF REFERENCE SIGNS

1 motor vehicle
2 radar system
3 radome
4 heating element
5 energy supply
6 processor
7 data memory
8 method scheme
9 initial state
10 standard operating mode
11 strong operating mode
12 standard characteristic curve
13 boost characteristic curve
S1-S4 method steps
v speed
P power

1.-10. (canceled)

11. A method of operating a heating device for a motor vehicle for heating a component exposed to an external environment in an intended installation position, the method comprising:
automatically monitoring whether a heating requirement for the component exists;
when a heating requirement is exists, the heating device is automatically operated in a predetermined standard operating mode designed for dry environmental conditions;
automatically monitoring whether there is an additional external cooling effect, which in each case currently cools the component and does not occur in dry environmental conditions; and
when no such additional external cooling effect is recognized, the heating device is operated further in the standard operating mode, and
when such an additional external cooling effect is recognized, the heating device is automatically operated in a strong operating mode, which is designed for wet environmental conditions and in which the heating device is operated using greater power than in comparison with the standard operating mode.

12. The method according to claim 11, wherein
to recognize the additional external cooling effect, the method monitors whether a temperature and/or temperature change reached is consistent with a predetermined expected value.

13. The method according to claim 11, wherein to recognize the additional external cooling effect, the method determines whether a rain sensor and/or an evaluation of camera image data for recognizing the respective current local weather conditions indicates wet environmental conditions.

14. The method according to claim 11, wherein
two different characteristic curves are predetermined for the heating device for the standard operating mode and the strong operating mode, and
the characteristic curve to be used for the strong operating mode provides a greater power at each point than the characteristic curve to be used for the standard operating mode at the same point.

15. The method according to claim 14, wherein
the characteristic curves specify the power to be applied in dependence on a speed of the motor vehicle equipped with the component and the heating device.

16. The method according to claim 11, wherein
the heating device is operated in the strong operating mode using a power which can result in overheating of the component without the additional external cooling effect.

17. The method according to claim 11, wherein
a change is made automatically from the strong operating mode back into the standard operating mode when monitoring carried out in the strong operating mode shows that:
(i) the additional external cooling effect no longer exists, and/or
(ii) a predetermined goal after a predetermined time span from the respective beginning of the strong operating mode has not been reached.

18. A control device for operating a heating device to heat a component of a motor vehicle, comprising:
a control unit operatively configured to:
automatically monitor whether a heating requirement for the component exists;
when a heating requirement exists, the heating device is automatically operated in a predetermined standard operating mode designed for dry environmental conditions;
automatically monitor whether there is an additional external cooling effect, which in each case currently cools the component and does not occur in dry environmental conditions;
when no such additional external cooling effect is recognized, the heating device is operated further in the standard operating mode, and
when such an additional external cooling effect is recognized, the heating device is automatically operated in a strong operating mode, which is designed for wet environmental conditions and in which the heating device is operated using greater power than in comparison with the standard operating mode.

19. A motor vehicle, comprising:
a component exposed to an external environment;
a heating system for heating the component, wherein the heating system comprises a heating device; and
a control unit operatively configured to:
automatically monitor whether a heating requirement for the component exists;
when a heating requirement exists, the heating device is automatically operated in a predetermined standard operating mode designed for dry environmental conditions;
automatically monitor whether there is an additional external cooling effect, which in each case currently cools the component and does not occur in dry environmental conditions;
when no such additional external cooling effect is recognized, the heating device is operated further in the standard operating mode, and
when such an additional external cooling effect is recognized, the heating device is automatically operated in a strong operating mode, which is designed for wet environmental conditions and in which the heating device is operated using greater power than in comparison with the standard operating mode.

20. The motor vehicle according to claim 19, wherein
the component heatable via the heating system is a radome of a radar device of the motor vehicle or a window.
